(19) United States
(12) Patent Application Publication
(10) Pub. No.: US 2024/0314884 A1
(43) Pub. Date: Sep. 19, 2024

(54) SENSING-ASSISTED MOBILITY MANAGEMENT

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 18/668,940

(22) Filed: May 20, 2024

Related U.S. Application Data
(63) Continuation of application No. PCT/CN2021/134802, filed on Dec. 1, 2021.

(51) Int. Cl. H04W 76/27

(52) U.S. Cl. CPC H04W 76/27

(57) ABSTRACT

Some embodiments of the present disclosure introduce dynamic capability extension and reduction for sensing-assisted mobility management. Capabilities of mobile communication devices may be dynamically extended and reduced to the benefit of sensing-assisted mobility management procedures carried out at a serving device. The mobile communication device may become associated with an object fitted with a plurality of sensors. The mobile communication device may report, to a serving device, an extended set of capabilities. The serving device may respond by providing, to the mobile communication device, configuration details for at least some of the sensors. Upon receipt, from the mobile communication device, of sensor measurement data, the serving device may be empowered to make sensor-data enhanced mobility management decisions.

### CROSS-REFERENCE TO RELATED APPLICATIONS

This application is a continuation of International Application No. PCT/CN2021/134802, filed on Dec. 1, 2021, which is hereby incorporated by reference in its entirety.

### TECHNICAL FIELD

The present disclosure relates, generally, to mobility management procedures in cellular communication systems and, in particular embodiments, to sensing-assisted mobility management.

### BACKGROUND

Mobility management procedures relate to procedures carried out by mobile communication devices in relation to serving devices or non-serving devices. Mobile communication devices are connected to serving devices. A service device is a device with which a mobile communication device has established a connection (by using, e.g., an initial access procedure) and the mobile communication device goes in connected state after completing the step of establishing a connection. Mobility management procedures relate, more particularly, to maintaining favorable communications conditions for the mobile communications devices by handing them over from one device (which is the serving device before the hand-over is initiated) to another device (which is the serving device after the hand-over has been completed). This Mobility Management procedure is called a “hand-over” procedure (sometimes abbreviated to “HO” procedure, sometimes called “Layer-3 based mobility”).

Current solutions for mobility management procedures in cellular communication systems are based on measurements, made at the mobile communications devices, and reporting, to the serving devices, of cell-based events that are based on the measurements. The tracking, at the mobile communication devices, of cell-based events may be shown to result in relatively poor performance in beam-based communication deployments, because a given user-based node may be configured to perform beam refinements to determine a “best” beam for communication purposes. The involvement of Layer-3-based procedures may be shown to cause mobility management procedures to be inherently high-latency due to messages having to travel across Layer 1 and Layer 2.

It is known that fifth generation (5G) (also known as “new radio” (NR)) mobile communication standards include support for Vehicular-to-Anything (V2X) communications. In particular, it is known that 5G standards include support for transmission of sidelink reference signals, e.g., Synchronization Signal and Physical Broadcast Channel (SS/PBCH) blocks and Channel State Information Reference Signals (CSI-RS). Similarly, it is known that the V2X support in the 5G standards includes support for transmission of sidelink physical layer channels, e.g., Physical Sidelink Control Channel (PSCCH) and Physical Sidelink Shared Channel (PSSCH).

Cell-based mobility events are typically used in mobility management procedures in 5G NR. Typical cell-based mobility events used in mobility management procedures include “Neighbor becomes amounts of offset better than PCell/PSCell” (known as “Event A3”) and “Neighbor becomes better than absolute threshold” (known as “Event A4”). Mobile communication devices are configured to monitor for the occurrence of mobility events and report to their serving devices upon detecting the occurrence of a mobility event.

Mobility management procedures in 5G NR are known to operate on the basis of detection and measurement of reference signals, i.e., SS/PBCH blocks or CSI-RS. Measurements of such reference signals may be shown to only reflect changes in the wireless environment. In one example, measurements of such reference signals allow for a determination of which reference signals have been received with the highest power.

Modern day mobile devices have a handheld form factor. The handheld form factor may be shown to inherently restrict the type of components that can be put into a mobile device. With limited storage capacity and limited battery capacity, there may not be enough space available to fit arrays of sensors within a mobile device.

### SUMMARY

According to aspects of the present application, capabilities of mobile communication devices may be dynamically extended and reduced to the benefit of sensing-assisted mobility management procedures carried out at the serving device. A mobile communication device may, upon becoming associated with an object fitted with sensors, report, to the serving device, the capabilities of the sensors. The serving device may, in turn, respond to receiving the report by providing mobile communication device with a configuration for the sensors, thereby dynamically extending the sensing capabilities associated with the mobile communication device.

Aspects of the present application are directed to taking advantage of the fact that objects, such as self-driving vehicles, are known to be equipped with arrays of sensors. Through an association between a mobile communication device and an object equipped with sensors, the mobile communication device may report, to a serving device that the mobile communication device has access to sensors well beyond the sensors typically included at a mobile communication device.

Indeed, the mobile communication device, through the association with the object, may have a capability to report things like a quantity of objects in the vicinity of the mobile communication device or a velocity of the objects in the vicinity of the mobile communication device.

Many benefits may be realized through the implementation of the sensing-assisted mobility management method according to aspects of the present application. For example, by extending the capabilities of a mobile communication device, a serving device may make use of received sensing measurement data to enhance future wireless communications between the serving device and the mobile communication device. That is, the sensing measurement data may be interpreted, at the serving device, in a manner that allows the serving device to obtain a representation of the environment surrounding the mobile communication device.

By extending the capabilities of the mobile communication device to include the capabilities of sensors fitted to an associated object, the serving device can make use of the information sensed, by the sensors, from the surrounding environment. The sensing device may use the information to enhance the wireless communications between the sensing device and the mobile communication device.

Through the act of transmitting, to the serving device, reports, the mobile communication device may be seen to allow for mobility decisions to be made, at the serving device, based on changes in the environment that surrounds the object with which the mobile communication device is associated. Those changes may, for example, relate to other vehicles traveling around in the environment of the mobile communication device.

Through the act of transmitting, to the sensing device, reports that are based on detection, reception and measurement of sidelink reference signals, the mobile communication device may be seen to allow for mobility decisions to be made, at the serving device, based on changes in the environment that surrounds the object with which the mobile communication device is associated. Those changes may, for example, relate to other vehicles traveling around in the environment of the mobile communication device.

According to an aspect of the present disclosure, there is provided a method for carrying out at a mobile communication device. The method includes receiving, from an object to which a sensor is fitted, sensing capability information for the sensor, transmitting, to a serving device, a first message including the sensing capability information and receiving, from the serving device, a second message including configuration information for the sensor and transmitting, to the associated object, the configuration information for the sensor.

An example of configuration information is higher-layer parameters transmitted by the serving device to a mobile communication device using, e.g., Radio Resource Control (RRC) protocol.

According to an aspect of the present disclosure, there is provided a method for carrying out at a serving device. The method includes receiving, from a mobile communication device, a first message including sensing capability information for a sensor associated with the mobile communication device, responsive to the receiving, transmitting, to the mobile communication device, a second message including configuration information for the sensor, receiving, from the mobile communication device, sensing measurement data obtained at the sensor, determining, from the sensing measurement data, that the mobile communication device is to be switched to a further serving device and transmitting, to the mobile communication device, instructions to switch to the further serving device.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices, including a generic self-driving vehicle, and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a signaling flow-chart capturing the behavior of a transmit receive point, an electronic device and a generic self-driving vehicle, all of FIG. 1, according to aspects of the present application;

FIG. 7 illustrates an example of a capability extension request message, sent by an electronic device of FIG. 1 using a higher-layer signaling message, according to aspects of the present application;

FIG. 8 illustrates an example of a capability extension response message, sent by a transmit receive point of FIG. 1 using a higher-layer signaling message, according to aspects of the present application;

FIG. 9 illustrates a signaling flow-chart capturing the behavior of a transmit receive point of FIG. 1 and a mining vehicle, according to aspects of the present application;

FIG. 10 illustrates a signaling flow-chart capturing the behavior of a transmit receive point, an electronic device and a generic self-driving vehicle, all of FIG. 1, according to aspects of the present application;

FIG. 11 illustrates a signaling flow-chart capturing the behavior of a transmit receive point and an electronic device of FIG. 1, and an object, according to aspects of the present application; and

FIG. 12 illustrates an example of a capability extension response message specific to sidelink reference signal measurement, sent by a transmit receive point of FIG. 1 using a higher-layer signaling message, according to aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

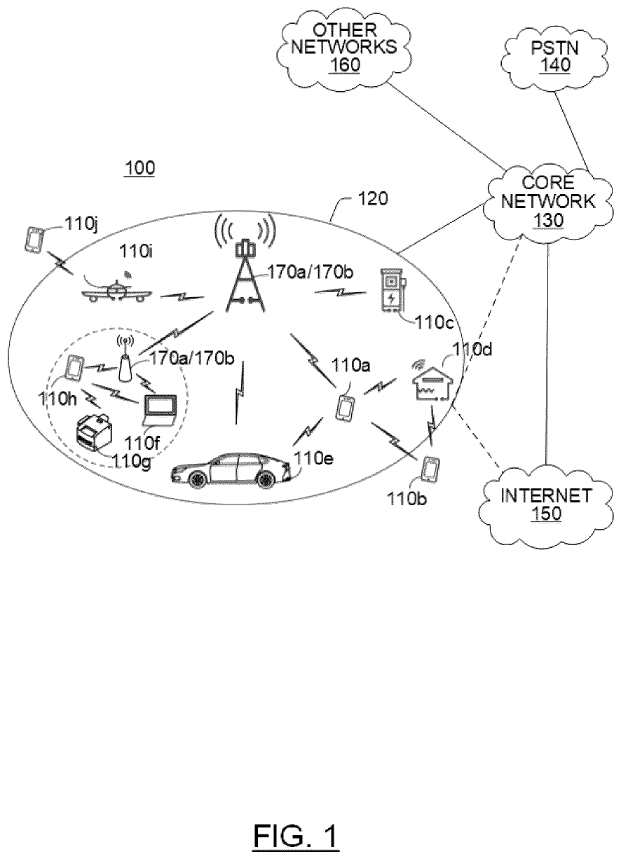

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

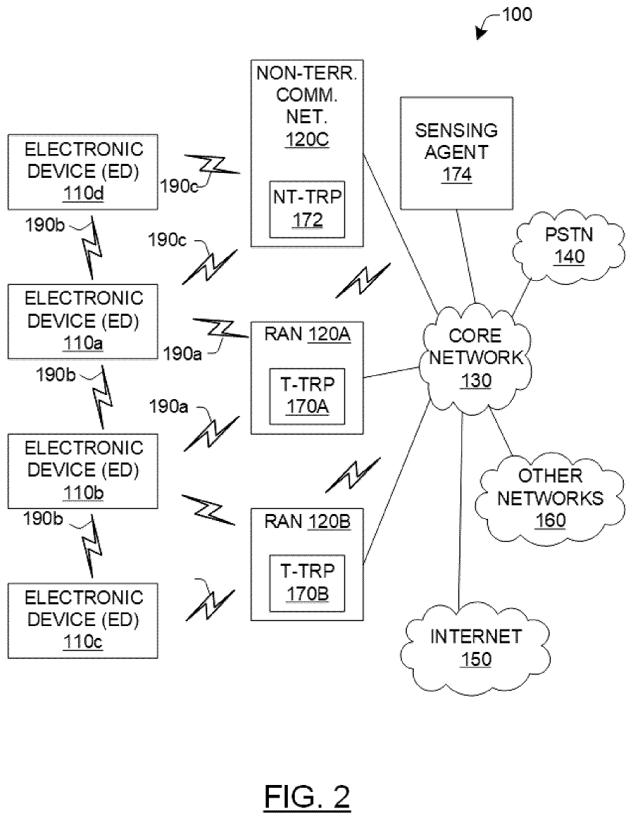

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

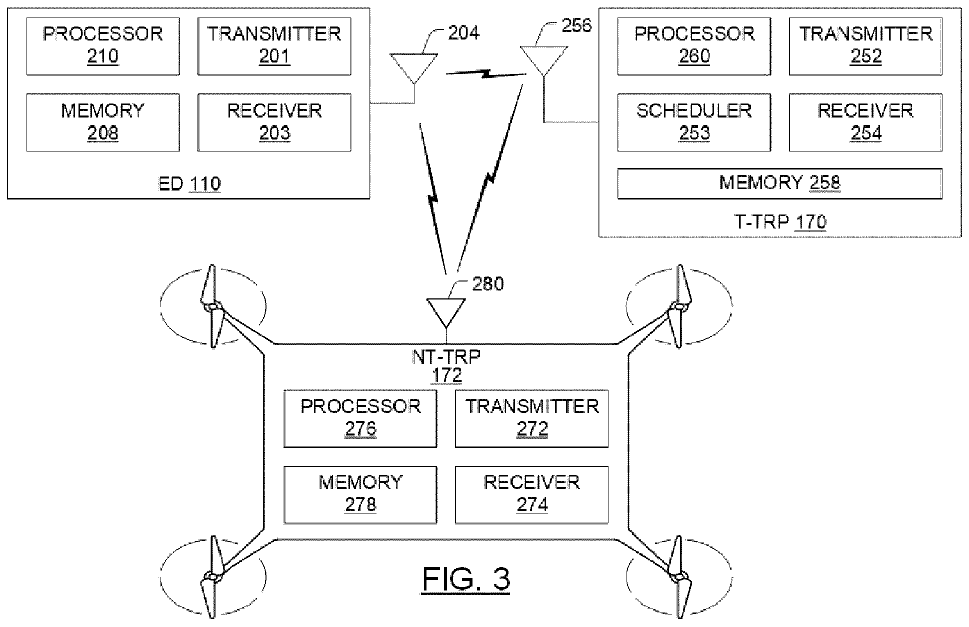

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

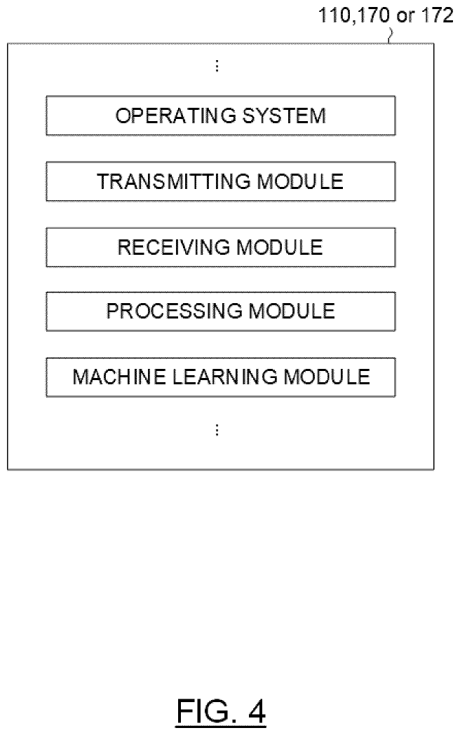

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., millimeter wave, “mmWave,” bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmWave band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE position information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE position and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE position determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

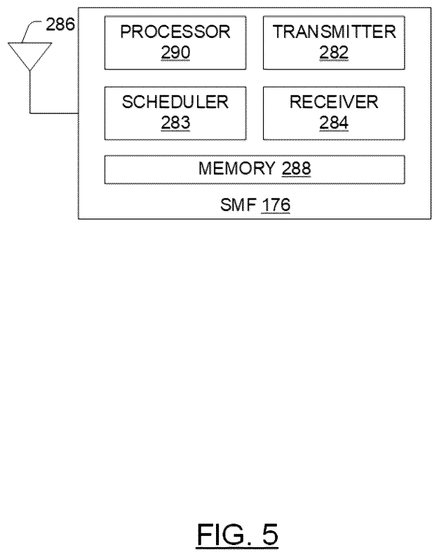

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based position determination technique belongs to an “active” position estimation paradigm. In an active position estimation paradigm, the enquirer of position information (e.g., the UE 110) takes part in process of determining the position of the enquirer. The enquirer may transmit or receive (or both) a signal specific to position determination process. Positioning techniques based on a global navigation satellite system (GNSS) such as the known Global Positioning System (GPS) are other examples of the active position estimation paradigm.

In contrast, a sensing technique, based on radar for example, may be considered as belonging to a “passive” position determination paradigm. In a passive position determination paradigm, the target is oblivious to the position determination process.

By integrating sensing and communications in one system, the system need not operate according to only a single paradigm. Thus, the combination of sensing-based techniques and reference signal-based techniques can yield enhanced position determination.

The enhanced position determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the position of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, because their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

Aspects of the present application relate to introducing dynamic UE capability extension and reduction for Sensing-Assisted communications.

Due to the UEs 110 having limited storage and battery capacity, the UEs 110 may not arrive for deployment fitted with a wide variety of sensors. However, other devices, such as self-driving vehicles, may be associated with a given UE 110 through an association procedure. The association procedure may be a passive association procedure or an active association procedure. Following this association procedure, the given UE 110 may transmit a capability extension request to the TRP 170 and, after the TRP 170 grants the request, sensing tasks can be assigned, by the given UE 110, to the associated device. The associated device may, for example, employ an available array of sensors to carry out the assigned sensing tasks. Sensing tasks may be carried out by sensors such as cameras, LIDAR systems, mmWave RADAR systems or other types of sensors.

By processing sensing information obtained by the sensors and received from the associated device, the given UE 110 may monitor the sensing information for specific information. Examples of such specific information include: information identifying a type for objects that are in the vicinity of the associated device; information related to a quantity of objects that are in the vicinity of the associated device; and information related to a velocity of the objects that are in the vicinity of the associated device.

Upon receiving the specific information from the associated device, the given UE 110 may transmit a report to the TRP 170. The report may, for example, include the sensing measurement data obtained through the carrying out of sensing tasks by the sensors. The report may, for example, include: an indication of a quantity of sensed objects; an indication of a type for each of the sensed objects; an indication of a radial velocity for each of the sensed objects; an indication of a sensing radius; an indication of a sensor identifier; etc. Responsive to receiving a report from the UE 110, the TRP 170 may make mobility-related decisions. The mobility-related decisions may, for example, relate to a handover or relate to switching the UE 110 from the T-TRP 170 to an NT-TRP 172.

Aspects of the present application may be found to be useful in the network 100 of FIG. 1, which network 100 has been described as including a variety of different devices, such as UEs 110a, 110b, 110h, 110j, fixed base-stations 170a, 170b and self-driving vehicles 110e.

It is assumed that a generic self-driving vehicle 110e is fitted with a variety of sensors. In particular, sensors that are known to be useful for the purpose of facilitating self-driving may include cameras, LIDAR systems and mmWave RADAR systems. It is also assumed that the generic self-driving vehicle 110e has an internal operating system, e.g., Unix™, Linux™, Android™, HarmonyOS™, etc. It is expected that the internal operating system serves to allow a driver and/or passengers to interact with various functions of the generic self-driving vehicle 110e. It is also expected that the internal operating system serves to allow other devices to connect with internal systems of the generic self-driving vehicle 110e.

Each sensor fitted in the generic self-driving vehicle 110e may be assumed to have a set of sensing capabilities, e.g., a sensing range, a sensing periodicity, a set of objects that may be sensed, etc. It may also be assumed that procedures exist that allow the generic self-driving vehicle 110e and a UE 110 to be “associated.” An association procedure may, for example, be initiated through application-level software. An association procedure may, for example, be initiated through a procedure, function, routine, sub-routine in the internal operating system running on the UE 110. Example manners in which the association may be established include: a Bluetooth™ link; a Wi-Fi™ link; a Uu link (i.e., a link using an air interface of the type used between a UE 110 and a Terrestrial Radio Access Network of the known Universal Mobile Telecommunications System or 4G Long Term Evolution or 5G New Radio); and a sidelink. The purpose of this association procedure is to establish a wireless link between the generic self-driving vehicle 110e and the UE 110, so that the generic self-driving vehicle 110e and the UE 110 may proceed to exchange information. The exchanged information may include information about sensor capability, sensor measurement data, sensor measurement reports.

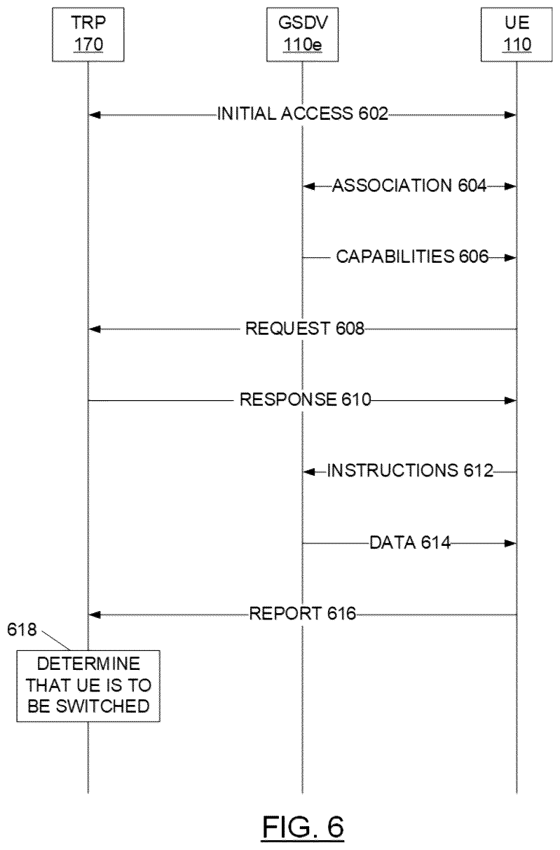

FIG. 6 illustrates a signaling flow-chart capturing the behavior of the TRP 170, the UE 110 and the generic self-driving vehicle 110e according to aspects of the present application.

To begin, the UE 110 and the TRP 170 exchange communication (602) to carry out a known initial access procedure. At the completion of the initial access procedure, the UE 110 may be considered to be in a “CONNECTED” state.

The UE 110 and the generic self-driving vehicle 110e next exchange communication (604) to carry out an association procedure, which can be initiated by the UE 110 or by the generic self-driving vehicle 110e. The purpose of the association procedure is to establish a two-way communication link between the UE 110 and the generic self-driving vehicle 110e, so that the UE 110 and the generic self-driving vehicle 110e can both send and/or receive physical layer transmissions to each-other. These physical layer transmissions can carry control data such as higher-layer signaling or can carry user-specific data such as traffic data. Examples of technologies through which association procedures between the UE 110 and the generic self-driving vehicle 110e may be carried out include: Bluetooth™; Wi-Fi™; a Uu; and sidelink.

After the exchange of communication (604) involved in the association procedure is completed, the UE 110 and the generic self-driving vehicle 110e may exchange information about the sensors in place at the generic self-driving vehicle 110e and the respective sensing capabilities of the sensors.

The generic self-driving vehicle 110e may, in general, have N₁ cameras, N₂ LIDAR systems and N₃ mmWave RADAR systems, where {N₁, N₂, N₃} are all independent positive integers. For example purposes, it may be assumed that the generic self-driving vehicle 110e is equipped with one front-facing camera, one rear-facing camera, one LIDAR system and one mmWave RADAR system. The generic self-driving vehicle 110e may transmit (606) information to the UE 110, using the link established as part of the association procedure. The information may include an indication, to the UE 110, of the various capabilities of the sensors at the generic self-driving vehicle 110e. It should be noted that the transmission (606) of information, over the established link from the generic self-driving vehicle 110e to the UE 110, occurs without the TRP 170 being aware of the transmission (606).

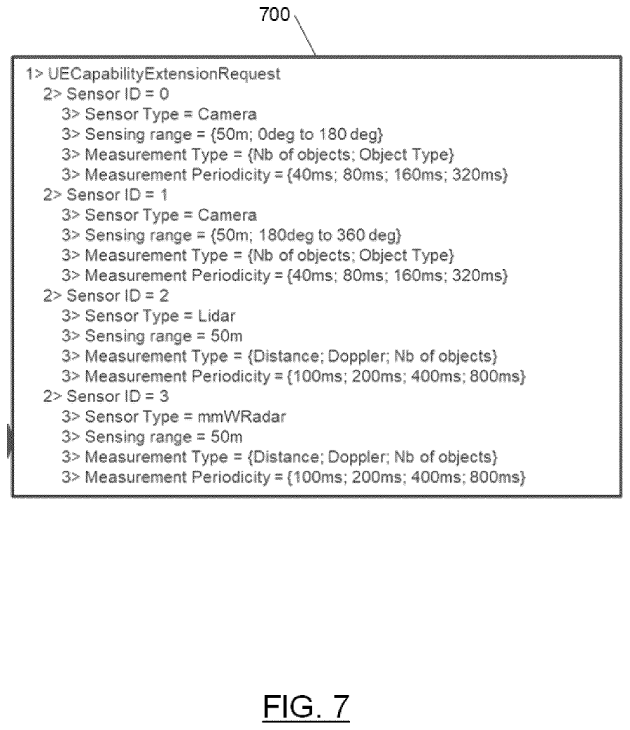

Once the UE 110 has received (606) sensing capability information from the generic self-driving vehicle 110e with which the UE 110 is associated, the UE 110 may transmit (608) a “UE Capability Extension request message” to a TRP 170. In some instances, the UE Capability Extension request message may be transmitted (608) as a higher-layer signaling message (e.g., using RRC signaling). In some other instances, the UE Capability Extension request message may be transmitted (608) as a lower-layer signaling message (e.g., using a media access control—control element, “MAC-CE”). The choice between using higher-layer signaling or lower-layer signaling for transmitting (608) the UE Capability Extension request message may be based on the size of the payload (i.e., the total number of bits) to be carried by the UE Capability Extension request message. An example of a UE Capability Extension request message 700, using a higher-layer signaling message, is illustrated in FIG. 7.

The higher-layer signaling (608) containing the UE Capability Extension request message 700 may be shown to allow the UE 110 to provide, to the TRP 170, a higher-layer parameter UECapabilityExtensionRequest. This parameter contains one or more entries, with each entry corresponding to one of the sensors fitted on the associated device (in this example, the generic self-driving vehicle 110e). Each entry may be associated with a higher-layer parameter, “Sensor ID,” which may be given as a positive integer value. For each entry, several other higher-layer parameters may be provided, such as a “Sensor Type” parameter, a “Sensing range” parameter, a “Measurement Type” parameter and a “Measurement Periodicity” parameter.

In one embodiment, the UE Capability Extension request message 700 may, instead, be a “Sensing Capability Extension request message.” The rationale for such a name is that the request message is for adding a sensing capability to the UE's existing or built-in capability. The higher-layer signaling 608 would then contain a higher-layer parameter SensingCapabilityExtensionRequest, which may have one or more entries and each entry may contain other higher-layer parameters such as Sensor ID, Sensor Type, Sensing range, Measurement Type and Measurement Periodicity.

In a second embodiment, the UE Capability Extension request message 700 may, instead, be a “Virtual Capability Extension request message.” The rationale for such a name is that the request message is for adding a virtual capability that corresponds to the “virtual device” or “super device” formed by the association of the UE 110 and the generic self-driving vehicle 110e. The higher-layer signaling 608 would then contain a higher-layer parameter VirtualCapability ExtensionRequest, which may have one or more entries and each entry containing other higher-layer parameters such as Sensor ID, Sensor Type, Sensing range, Measurement Type and Measurement Periodicity.

In a third embodiment, the UE Capability Extension request message 700 may, instead, be an “Enhanced Capability Extension request message.” The rationale for such a name is that the request message is for adding an enhanced capability such as sensing to the UE's existing or built-in capability. The higher-layer signaling 608 would then contain a higher-layer parameter EnhancedCapabilityExtensionRequest, which may have one or more entries and each entry containing other higher-layer parameters such as Sensor ID, Sensor Type, Sensing range, Measurement Type and Measurement Periodicity.

Other higher-layer parameters that may be provided for one of the sensors fitted on the associated device in the UE Capability Extension request message 700 are: a “Sensing resolution accuracy” parameter; a “Sensing frequency band” parameter; a “Number of receivers” parameter; a “Number of transmitters” parameter; a “Phase Noise” parameter; a “Noise Figure” parameter; an “Output power” parameter; a “Sampling rate” parameter; an “Image resolution” parameter; a “Frame rate” parameter; an “Angular resolution accuracy” parameter; a “Scanning angle” parameter; and a “Scanning periodicity” parameter.

For a given sensor, the Sensor Type parameter may be used to indicate a type. That is, the Sensor Type parameter may be used to indicate that the given sensor is, e.g., a camera, a LIDAR system, a mmWave RADAR system, etc.

For a given sensor, the Sensing range parameter may be used to indicate a sensing radius of the given sensor. The Sensing range parameter may, additionally, indicate an area covered by the given sensor. The area covered may be expressed, e.g., as an angular range.

For a given sensor, the Measurement Type parameter may be used to indicate a type of measurement that can be carried out using the given sensor. The Measurement Type parameter may indicate that a quantity of objects may be sensed by the given sensor. The Measurement Type parameter may indicate that there exists a limit to the number of objects that may be sensed by the given sensor. The Measurement Type parameter may indicate a type of object that may be sensed by the given sensor. The Measurement Type parameter may indicate a distance from the given sensor to an object. The Measurement Type parameter may indicate that a radial velocity of an object may be sensed by the given sensor.

For a given sensor, the Measurement Periodicity parameter may be used to indicate measurement periodicities supported by the given sensor.

For a given sensor, the Sensing resolution accuracy parameter may be used to indicate the sensing resolution accuracies (e.g., 1 cm) supported by the given sensor.

For a given sensor, the Sensing frequency band parameter may be used to indicate the frequency bands (e.g., 71 GHz) supported by the given sensor.

For a given sensor, the Number of receivers parameter may be used to indicate the number of receivers (e.g., 2) supported by the given sensor.

For a given sensor, the Number of transmitters parameter may be used to indicate the number of transmitters (e.g., 2) supported by the given sensor.

For a given sensor, the Phase noise parameter may be used to indicate the different phase noises (e.g., −100 dBc/Hz) supported by the given sensor.

For a given sensor, the Noise figure parameter may be used to indicate the different noise figures (e.g., 5 dB) supported by the given sensor.

For a given sensor, the Output power parameter may be used to indicate the different output powers (e.g., 10 dBm) supported by the given sensor.

For a given sensor, the Sampling rate parameter may be used to indicate the different sampling rates (e.g., 10 samples per second) supported by the given sensor.

For a given sensor, the Image resolution parameter may be used to indicate the different image resolutions (e.g., 300 picture elements or “pixels” per inch) supported by the given sensor.

For a given sensor, the Frame rate parameter may be used to indicate the different frame rates (e.g., 60 frames per second) supported by the given sensor.

For a given sensor, the Angular resolution accuracy parameter may be used to indicate the different angular resolution accuracies (e.g., 0.1 degrees) supported by the given sensor.

For a given sensor, the Scanning angle parameter may be used to indicate the different scanning angles (e.g., 360 degrees) supported by the given sensor.

For a given sensor, the Scanning periodicity parameter may be used to indicate the different scanning periodicities (e.g., performing a number of angular range scans in a given duration) supported by the given sensor.

In some embodiments, the content of the UE Capability Extension request message 700 transmitted (608) by the UE 110 is identical to the content of the sensing capability information transmitted (606) by the generic self-driving vehicle 110e. As part of the UE Capability Extension request message 700, the UE 110 may report the real sensing capability of the generic self-driving vehicle 110e to the TRP 170.

In some embodiments, the content of the UE Capability Extension request message 700 transmitted (608) by the UE 110 is different from the content of the sensing capability information transmitted (606) by the generic self-driving vehicle 110e. As part of the UE Capability Extension request message 700, the UE 110 may report a filtered version of the sensing capability of the generic self-driving vehicle 110e to the TRP 170.

In some embodiments, the content of the UE Capability Extension request message 700 transmitted (608) by the UE 110 is different from the content of the sensing capability information transmitted (606) by the generic self-driving vehicle 110e. As part of the UE Capability Extension request message 700, the UE 110 may report a modified version of the sensing capability of the generic self-driving vehicle 110e to the TRP 170.

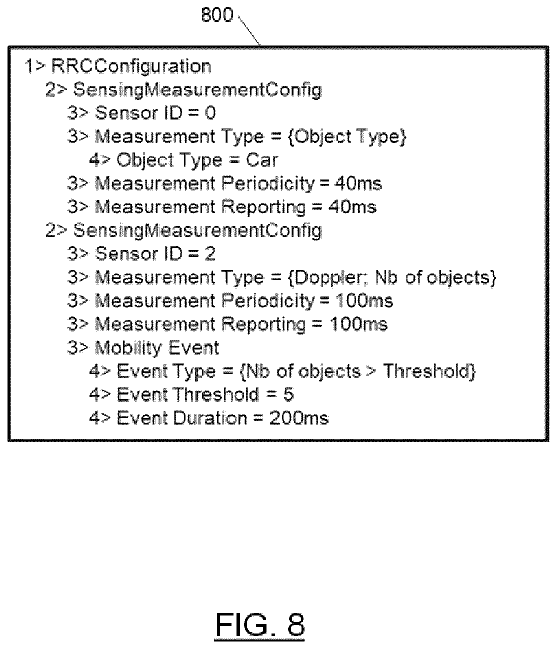

After receiving (608), from the UE 110, the UE Capability Extension request message, the TRP 170 may respond by transmitting (610), to the UE 110, a UE Capability Extension response. An example UE Capability Extension response 800 is illustrated in FIG. 8. The UE Capability Extension response may, implicitly or explicitly, indicate that the UE Capability Extension request has been granted. The TRP 170 may use the transmission (610) of the UE Capability Extension response to configure a manner by which the device associated with the UE 110 is to carry out sensing-based measurement tasks.

Because the capabilities of the sensors at the generic self-driving vehicle 110e may be considered, by the TRP 170, to be the capabilities of sensors at the UE 110, it may be considered that the capabilities of the UE 110 have been dynamically expanded through the association of the UE with the generic self-driving vehicle 110e. The capabilities of the UE 110 and the generic self-driving vehicle 110e may be considered to have been effectively joined together to form a “virtual device” or “super device” or “enhanced device.”

In some embodiments, the UE Capability Extension request message 700 may, instead, be a “Sensing Capability Reduction request message.” The rationale for such a name is that the request message is for removing a sensing capability to the UE's current capability because the associated device is no longer associated to the UE 110. The higher-layer signaling 608 would then contain a higher-layer parameter SensingCapabilityReductionRequest, which may have one or more entries and each entry containing other higher-layer parameters such as Sensor ID, Sensor Type, Sensing range, Measurement Type and Measurement Periodicity.

In some embodiments, the UE Capability Extension request message 700 may, instead, be a “Virtual Capability Reduction request message.” The rationale for such a name is that the request message is for removing a virtual capability that corresponded to the “virtual device” or “super device” formed by the association of the UE 110 and the generic self-driving vehicle 110e, which is no longer there after the UE 110 has become dis-associated from the generic self-driving vehicle 110e. The higher-layer signaling 608 would then contain a higher-layer parameter VirtualCapabilityReductionRequest, which may have one or more entries and each entry containing other higher-layer parameters such as Sensor ID, Sensor Type, Sensing range, Measurement Type and Measurement Periodicity.

In some embodiments, the UE Capability Extension request message 700 may, instead, be an “Enhanced Capability Reduction request message.” The rationale for such a name is that the request message is for removing an enhanced capability such as sensing to the UE's existing or built-in capability. The higher-layer signaling 608 would then contain a higher-layer parameter EnhancedCapabilityReductionRequest, which may have one or more entries and each entry containing other higher-layer parameters such as Sensor ID, Sensor Type, Sensing range, Measurement Type and Measurement Periodicity.

In some embodiments, the UE Capability Extension request message 700 may, instead, be a “Sensing Capability Modification request message.” The rationale for such a name is that the request message is for modifying a sensing capability to the UE's current capability because the associated device updated its own capabilities. The higher-layer signaling 608 would then contain a higher-layer parameter SensingCapabilityModificationRequest, which may have one or more entries and each entry containing other higher-layer parameters such as Sensor ID, Sensor Type, Sensing range, Measurement Type and Measurement Periodicity.

In some embodiments, the UE capability Extension request message 700 may, instead, be a “Virtual Capability Modification request message.” The rationale for such a name is that the request message is for modifying a virtual capability that corresponds to the “virtual device” or “super device” formed by the association of the UE 110 and the generic self-driving vehicle 110e. The higher-layer signaling 608 would then contain a higher-layer parameter VirtualCapabilityModificationRequest, which may have one or more entries and each entry containing other higher-layer parameters such as Sensor ID, Sensor Type, Sensing range, Measurement Type and Measurement Periodicity.

In some embodiments, the UE Capability Extension request message 700 may, instead, be called an “Enhanced Capability Modification request message.” The rationale for such a name is that the request message is for modifying an enhanced capability such as sensing to the UE's existing or built-in capability. The higher-layer signaling 608 would then contain a higher-layer parameter EnhancedCapabilityModificationRequest, which may have one or more entries and each entry containing other higher-layer parameters such as Sensor ID, Sensor Type, Sensing range, Measurement Type and Measurement Periodicity.

In some embodiments the UE Capability Extension request message 700 may include a higher-layer parameter CapabilityReconfigurationType, which may take one value within the set {Addition, Modification, Deletion}. Depending on whether the UE 110 is looking to add, modify or delete a sensing-related capability, the higher-layer parameter Capability ReconfigurationType may be set to the appropriate value.

As illustrated in FIG. 8, the TRP 170 may provide the UE 110 with a higher-layer signaling message including the UE Capability Extension response 800 that contains one or more entries of a higher-layer parameter SensingMeasurementConfig. For each individual entry, values for several parameters may be provided. The TRP 170 may provide the UE 110 with a value for the Sensor ID parameter. The TRP 170 may provide the UE 110 with a value for the Measurement Type parameter. The TRP 170 may provide the UE 110 with a value for the Measurement Periodicity parameter. The TRP 170 may provide the UE 110 with a value for the Measurement Reporting parameter.

It is notable that the UE Capability Extension request message 700 (see FIG. 7) includes capability information for four sensors and the UE Capability Extension response 800 (see FIG. 8) includes measurement configuration information for only two sensors. Accordingly, the extended capabilities of the UE 110 may be limited, for example, down to only those sensors for which the TRP 170 desires sensor measurement data.

In some embodiments, the TRP 170 sends a higher-layer configuration message to the UE 110, e.g., an “RRC reconfiguration message” comprising higher-layer parameters for at least one sensor fitted at the generic self-driving vehicle 110e. One purpose for the TRP 170 to send this message is to update the UE 110′s existing configuration for sensing-assisted mobility measurements.

In one embodiment, the higher-layer configuration message includes configuration information, using, e.g., the higher-layer parameter SensingMeasurementConfig, for a sensor with a different Sensor ID, as well as different Measurement Type, different Measurement Periodicity, different Measurement Reporting and different Mobility Event.

In a second embodiment, the higher-layer configuration message includes configuration, using, e.g., the higher-layer parameter Sensing MeasurementConfig, for the sensor with the same Sensor ID, but at least one of the higher-layer parameters with a different Measurement Type, Measurement Periodicity, Measurement Reporting or different Mobility Event.

In some embodiments, the higher-layer parameter Measurement Type may instead be called Sensing Measurement Type, the higher-layer parameter Measurement Periodicity may instead be called Sensing Measurement Periodicity, the higher-layer parameter Measurement Reporting may instead be called Sensing Measurement Reporting, the higher-layer parameter Mobility Event may instead be called Sensing Event, the higher-layer parameter Event Type may instead be called Sensing Event Type, the higher-layer parameter Event Threshold may instead be called Sensing Event Threshold, the higher-layer parameter Event Duration may instead be called Sensing Event Duration.

In some embodiments, the higher-layer parameter Measurement Type may indicate a number of vehicles (e.g., Number of trucks) such as trucks for the sensor to sense. Other examples of what the higher-layer parameter Measurement Type may indicate for the sensor to sense include e.g. Number of motor-cycles (denoting a number of motor-cycles), Number of cycles (denoting a number of cycles), Number of pedestrians (denoting a number of pedestrians). The sensor will perform sensing based on the indication of the higher-layer parameter Measurement Type.

In some embodiments, the higher-layer parameter Measurement Type may indicate a combination of a number of vehicles (e.g., Number of cars and Number of trucks) or a combination of a number of vehicles and pedestrians (e.g., Number of cars and Number of pedestrians).

In some embodiments, the higher-layer parameter SensingMeasurementConfig comprises the following higher-layer parameters: Sensor ID, Sensing Measurement Type, Sensing Measurement Periodicity and Sensing Measurement Reporting. This configures the sensor identified with Sensor ID to perform sensing in a periodic manner based on Sensing Measurement Type with a periodicity given by Sensing Measurement Periodicity and to report sensing measurements results with a periodicity given by Sensing Measurement Reporting.

In some embodiments, the higher-layer parameter SensingMeasurementConfig comprises the following higher-layer parameters: Sensor ID, Sensing Measurement Type, Sensing Mobility Event, Sensing Event Type, Sensing Event Threshold and Sensing Event Duration. This configures the sensor identified with Sensor ID to perform sensing in an event-based manner based on Sensing Measurement Type where the sensor monitors for events indicated by Sensing Event Type, a threshold indicated by Sensing Event Threshold and a duration indicated by Sensing Event Duration.

Notably, although it is the UE 110 that receives (610), from the TRP 170, the higher-layer signaling message containing the SensingMeasurementConfig parameter, the actual sensing measurements are carried out by the device that is associated with the UE 110. In this example, the device that is associated with the UE 110 is the generic self-driving vehicle 110e. Accordingly, responsive to receiving (610), from the TRP 170, the higher-layer signaling message containing the SensingMeasurementConfig parameter, the UE 110 may transmit (612), to the generic self-driving vehicle 110e, corresponding configuration information.

The generic self-driving vehicle 110e, responsive to receiving (612), from the UE 110, configuration information, may commence using the sensors to obtain sensing measurement data. The generic self-driving vehicle 110e may then transmit (614) the sensing measurement data to the UE 110. Upon receiving (614) the sensing measurement data, the UE 110 may transmit (616) the sensing measurement data to the TRP 170. Upon receiving (616) the measurements, the TRP 170 may determine (step 618) that the UE 110 is to be transferred from the TRP 170 to an NT-TRP 172. In the specific case wherein the device that is associated with the UE 110 is a mining vehicle, the determining (step 618) may be based on features of an environment surrounding the mining vehicle. An example feature of the environment surrounding the mining vehicle may relate to an amount of vehicular traffic on a road on which the mining vehicle is operating. Another example feature of the environment surrounding the mining vehicle may relate to network traffic offloading algorithms.

By assuming that a given set of mining vehicles (MVs) are equipped with cellular communication system components (e.g., a cellular modem and a set of physical antennas), it may be understood that each MV in the given set may be understood to act as a UE 110. The cellular communication system components of the MV may also be referred to as a Mining UE.

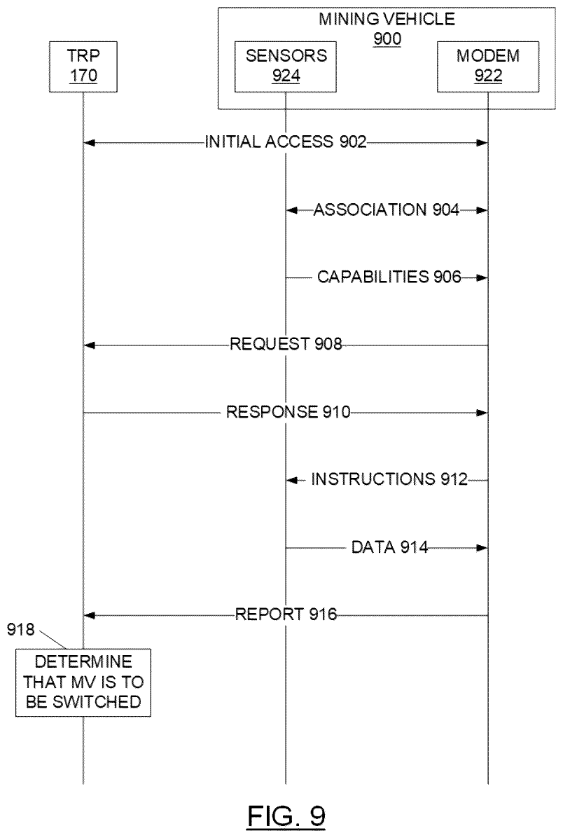

FIG. 9 illustrates a signaling flow-chart capturing the behavior of the TRP 170, and a mining vehicle 900 according to aspects of the present application. The mining vehicle 900 includes a cellular modem 922 and a plurality of sensors 924.

To begin, the cellular modem 922 and the TRP 170 exchange communication (902) to carry out a known initial access procedure. At the completion of the initial access procedure, the MV 900 may be considered to be in a “CONNECTED” state.

The cellular modem 922 on the MV 900 and the plurality of sensors 924 on the MV 900 next exchange communication (904) to carry out an association procedure. As described hereinbefore, example manners in which the association may be established include: a Bluetooth™ link; a Wi-Fi™ link; a Uu link; and a sidelink. After the exchange of communication (904) involved in the association procedure is completed, the cellular modem 922 may exchange information with the plurality of sensors 924. The information may relate to the sensing capabilities of each sensor among the plurality of sensors 924.

The MV 900 may, in general, have N₁ cameras, N₂ LIDAR systems and N₃ mmWave RADAR systems, where {N₁, N₂, N₃} are all positive integers. For example purposes, it may be assumed that the MV 900 is equipped with four sensors 924: one front-facing camera; one rear-facing camera; one LIDAR system; and one mmWave RADAR system. The sensors 924 may transmit (906) information to the cellular modem 922, using the link established as part of the association procedure to transmit information to the cellular modem. The information may include an indication, to the cellular modem 924, of the various capabilities of the plurality of sensors 924. It should be noted that that the transmission (906) of information, over the established link from the sensors 924 to the cellular modem 922, occurs at the MV 900 without the TRP 170 being aware of the transmission (906).

Once the cellular modem 922 has received (906) sensing capability information from the plurality of sensors 924 with which the cellular modem 922 is associated, the cellular modem 922 may transmit (908) a “UE Capability Extension request message” to the TRP 170. As discussed hereinbefore, in some instances, the UE Capability Extension request message may be transmitted (908) as a higher-layer signaling message (e.g., using RRC signaling). In some other instances, the UE Capability Extension request message may be transmitted (908) as a lower-layer signaling message (e.g., using a MAC-CE). The choice between using higher-layer signaling or lower-layer signaling for transmitting (908) the UE Capability Extension request message may be based on the size of the payload (i.e., the total number of bits) to be carried by the UE Capability Extension request message. Recall that the example UE Capability Extension request message 700, using a higher-layer signaling message, is illustrated in FIG. 7.

The higher-layer signaling (908) containing the UE Capability Extension request message 700 may be shown to allow the cellular modem 922 to provide, to the TRP 170, a higher-layer parameter UECapabilityExtensionRequest. This parameter contains one or more entries, with each entry corresponding to one of the plurality of sensors 924 fitted on the MV 900. Each entry may be associated with a higher-layer parameter, “Sensor ID,” which may be given as a positive integer value. For each entry, several other higher-layer parameters may be provided, such as a “Sensor Type” parameter, a “Sensing range” parameter, a “Measurement Type” parameter and a “Measurement Periodicity” parameter.

After receiving (908), from the cellular modem 924, the UE Capability Extension request message, the TRP 170 may respond by transmitting (910), to the MV 900, a UE Capability Extension response like the example UE Capability Extension response 800 illustrated in FIG. 8. The UE Capability Extension response may, implicitly or explicitly, indicate that the UE Capability Extension request has been granted. The TRP 170 may use the transmission (910) of the UE Capability Extension response to configure a manner by which the plurality of sensors 924 at the MV 900 are to carry out sensing-based measurement tasks.

Notably, although it is the cellular modem 922 that receives (910), from the TRP 170, the higher-layer signaling message containing the SensingMeasurementConfig parameter, the actual sensing measurements are carried out by the plurality of sensors 924 that are associated with the cellular modem 922. Accordingly, responsive to receiving (910), from the TRP 170, the higher-layer signaling message containing the SensingMeasurementConfig parameter, the cellular modem 922 may transmit (912), to the plurality of sensors 924, corresponding configuration information.

The plurality of sensors 924, responsive to receiving (912), from the cellular modem 922, configuration information, may commence obtaining measurements. The plurality of sensors 924 may then transmit (914) the sensing measurement data to the cellular modem 922. Upon receiving (914) the measurements, the cellular modem 922 may transmit (916) the sensing measurement data to the TRP 170. Upon receiving (916) the measurements, the TRP 170 may determine (step 918) that the cellular modem 922 is to be transferred from the TRP 170 to an NT-TRP 172. In the specific case wherein the device that is associated with the UE 110 is a mining vehicle, the determining (step 918) may be based on the sensed nature of the surrounding environment, e.g., high temperatures or working conditions deemed unsafe for people.

In aspects of the present application, it may be assumed that the UE 110 is associated with a particular vehicle 110e traveling on a road. The UE 110 may be connected with a T-TRP 170 and it may be assumed that there are other vehicles traveling on the road in the vicinity of the particular vehicle 110e.

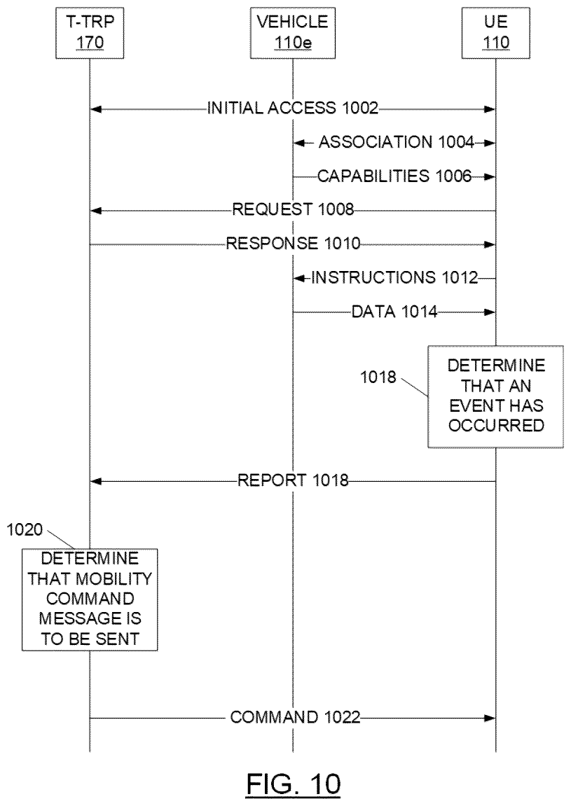

FIG. 10 illustrates a signaling flow-chart capturing the behavior of the T-TRP 170, the UE 110 and the particular vehicle 110e according to aspects of the present application.

To begin, the UE 110 and the T-TRP 170 exchange communication (1002) to carry out a known initial access procedure. At the completion of the initial access procedure, the UE 110 may be considered to be in a “CONNECTED” state.

The UE 110 and the particular vehicle 110e next exchange communication (1004) to carry out an association procedure. After the exchange of communication (1004) involved in the association procedure is completed, the UE 110 and the vehicle 110e may exchange information about the sensors in place at the vehicle 110e and the respective sensing capabilities of the sensors.

The particular vehicle 110e may transmit (1006) information to the UE 110, using the link established as part of the association procedure. The information may include an indication, to the UE 110, of the various capabilities of the sensors at the particular vehicle 110e.

Once the UE 110 has received (1006) sensing capability information from the particular vehicle 110e with which the UE 110 is associated, the UE 110 may transmit (1008) a “UE Capability Extension request message” to the T-TRP 170. Recall that the example UE Capability Extension request message 700, using a higher-layer signaling message, is illustrated in FIG. 7.

After receiving (1008), from the UE 110, the UE Capability Extension request message, the T-TRP 170 may respond by transmitting (1010), to the UE 110, a UE Capability Extension response like the example UE Capability Extension response 800 illustrated in FIG. 8.

Sensing-Assisted Mobility measurements may be considered to be sensing-based measurements carried out for the purpose of Mobility Management. The UE Capability Extension response may, as illustrated in FIG. 8, include configuration details that act to instruct the UE 110 to arrange sensing by certain indicated sensors, as identified by their sensor ID. It is expected that the sensors are fitted on the associated device (i.e., the particular vehicle 110e).

The UE 110 may transmit (1012), to the particular vehicle 110e, e.g., using a sidelink, configuration information to cause the sensors to carry out respective sensing measurements. The sensors carry out the obtaining of sensing measurement data, in accordance with the configuration information provided to the UE 110 by the T-TRP 170. The particular vehicle 110e may then transmit (1014) the sensing measurement data to the UE 110. Notably, the sensing measurement data transmitted (1014) from the particular vehicle 110e to the UE 110 may have a pre-defined format. Alternatively, the sensing measurement data transmitted (1014) from the associated device to the UE 110 may have a proprietary format. The Sensing Measurement report transmitted (1018) from the particular vehicle 110e to the UE 110 may include fields designated to carry values for the Sensor ID, the number of sensed vehicles, the type of sensed vehicles, the distance to the sensed vehicles, the radial velocity of the sensed vehicles, the Sensing Event type, etc. The values carried in these fields can be positive integer/decimal/real values, strings of characters or values from an enumerated table.

Upon receiving (1014) the sensing measurement data, the UE 110 may determine (step 1016) that a Sensing-Assisted Mobility event has occurred. Responsive to the determining (step 1016), the UE 110 may produce a Sensing Measurement report. The UE 110 may then transmit (1018) the Sensing Measurement report to the T-TRP 170. For example, a Sensing-Assisted Mobility event may be configured to be triggered if the Sensing Measurement report from the generic self-driving vehicle 110e for a given sensor identity Sensor ID includes an indication that a certain number (say, two) of sensed vehicles (i.e., number of sensed vehicles=2) have been sensed within a certain distance (say ten meters, i.e., distance to the sensed vehicles<10) of the generic self-driving vehicle 110e for a certain duration (say, ten seconds, i.e., duration=10). Effectively, this configures the generic self-driving vehicle 110e to sense whether there are at least two vehicles around it, within a distance of ten meters, for at least ten seconds. For another example, a Sensing-Assisted Mobility event may be configured to be triggered if the Sensing Measurement report from the generic self-driving vehicle 110e for a given sensor identity Sensor ID includes an indication that a certain number (say, two) of sensed vehicles (i.e., number of sensed vehicles=2) have been sensed within a certain distance (say, ten meters, i.e., distance to the sensed vehicles<10) of the generic self-driving vehicle 110e for a certain duration (say, ten seconds, i.e., duration=10) with an added constraint that the sensed vehicles are the same for the duration of the Sensing-Assisted Mobility event. For a further example, a Sensing-Assisted Mobility event may be configured to be triggered if the Sensing Measurement report from the generic self-driving vehicle 110e for a given sensor identity Sensor ID includes an indication that a certain number (say, two) of sensed vehicles (i.e., number of sensed vehicles=2) have been sensed within a certain distance (say, ten meters, i.e., distance to the sensed vehicles<10) of the generic self-driving vehicle 110e for a certain duration (say, ten seconds, i.e., duration=10) with an added constraint that the radial velocity of the sensed vehicles is beyond a certain threshold (say, T, i.e., radial velocity>T).

The UE 110 may transmit (1018) the Sensing Measurement report to the T-TRP 170 over, e.g., a PUCCH or a PUSCH. The Sensing Measurement report transmitted (1018) from the UE 110 to the T-TRP 170 may include fields designated to carry values for the Sensor ID, the number of sensed vehicles, the type of sensed vehicles, the distance to the sensed vehicles, the radial velocity of the sensed vehicles, the Sensing Event type, the cellular radio network temporary identifier (C-RNTI) of the UE 110, etc. The values carried in these fields can be positive integer/decimal/real values, strings of characters or values from an enumerated table.

One example of determining (step 1016) that a Sensing-Assisted Mobility event has occurred relates to detecting that a value for the number of vehicles, received (1014) amongst the data from the particular vehicle 110e, is higher than a particular threshold. The particular threshold may be configured, by the T-TRP 170 for the UE 110, using higher-layer parameter Mobility Event as illustrated in the example UE Capability Extension response 800 (FIG. 8). The Mobility Event parameter may be further described using higher-layer parameters: an Event Type parameter; an Event Threshold parameter; and an Event Duration parameter. The Event Type parameter may be used to describe the event to be triggered. The Event Threshold parameter may provide a value for the threshold for the event to be triggered. The Event Duration parameter may be provide a value for an amount of time the value needs to exceed the threshold for the event to be triggered.

Following the reception (1018) of the Sensing Measurement report from the UE 110, the T-TRP 170 may then determine (step 1020) that a Mobility Command message is to be transmitted (1022) to the UE 110. In some instances, the Mobility Command message may be transmitted (1022), to the UE 110, as a higher-layer signaling message (e.g., using RRC signaling). In some other instances, the Mobility Command message may be transmitted (1022), to the UE 110, as a lower-layer signaling message (e.g., using a MAC-CE).

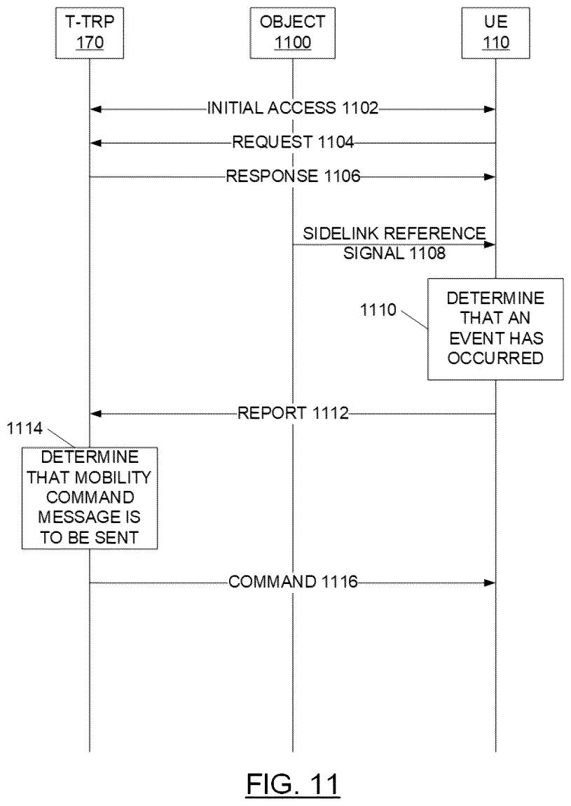

In aspects of the present application, it may be assumed that the UE 110 is associated with a vehicle (not shown) traveling on a road. The UE 110 may be connected with a T-TRP 170 and it may be assumed that there are other vehicles traveling on the road in the vicinity of the associated vehicle and other objects in the environment. An example object 1100 is illustrated in FIG. 11 and may be considered to represent a vehicle or another object.

FIG. 11 illustrates a signaling flow-chart capturing the behavior of the T-TRP 170, the UE 110 and the object 1100 according to aspects of the present application.

To begin, the UE 110 and the T-TRP 170 exchange communication (1102) to carry out a known initial access procedure. At the completion of the initial access procedure, the UE 110 may be considered to be in a “CONNECTED” state.

The UE 110 and the associated vehicle next exchange communication to carry out an association procedure. After the exchange of communication involved in the association procedure is completed, the UE 110 and the associated vehicle may exchange information about the sensors in place at the associated vehicle and the respective sensing capabilities of the sensors.

The associated vehicle may transmit information to the UE 110, using the link established as part of the association procedure. The information may include an indication, to the UE 110, of the various capabilities of the sensors at the associated vehicle.

Once the UE 110 has received sensing capability information from the vehicle with which the UE 110 is associated, the UE 110 may transmit (1104) a “UE Capability Extension request message” to the T-TRP 170. Recall that an example UE Capability Extension request message 700, using a higher-layer signaling message, is illustrated in FIG. 7.

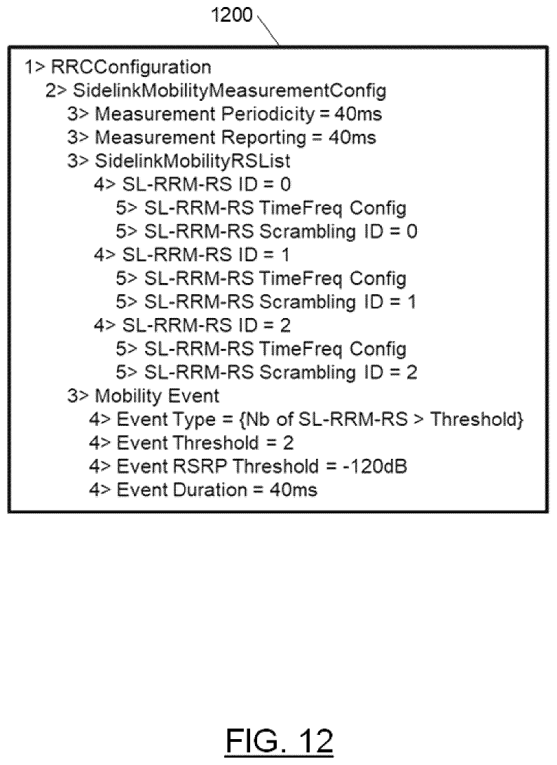

After receiving (1104), from the UE 110, the UE Capability Extension request message, the T-TRP 170 may respond by transmitting (1106), to the UE 110, a UE Capability Extension response containing a higher-layer parameter SidelinkMobilityMeasurementConfig, containing configuration for measurements that are to be based on sidelink reference signals transmitted by other devices in the environment of the UE 110 and the associated vehicle. An example UE Capability Extension response 1200, including the SidelinkMobilityMeasurementConfig parameter, is illustrated in FIG. 12.

Sidelink Mobility measurements may be understood to be measurements carried out on sidelink reference signals transmitted by surrounding objects, e.g., the object 1100 and/or nearby vehicles. The SidelinkMobilityMeasurementConfig parameter may include configuration details that act to instruct the UE 110 to arrange detection of sidelink reference signals and, once the sidelink reference signals have been detected, measurement of the sidelink reference signals. As illustrated in FIG. 12, the configuration details in the SidelinkMobilityMeasurementConfig parameter may include: an indication of a sidelink reference signal identifier; an indication of time/frequency resources employed by the sidelink reference signals; and an indication of a scrambling identifier that may be associated with a given sidelink reference signal.

The object 1100 may transmit (1108) a sidelink reference signal.

The UE 110 arranges the carrying out of detection, reception (1108) and measurement of the sidelink reference signal in accordance with the configuration provided by the T-TRP 170. Notably, although it is the UE 110 that receives (1106), from the T-TRP 170, the higher-layer signaling message containing the SidelinkMobilityMeasurementConfig parameter, the actual sensing measurements are carried out by the sensors at the vehicle that is associated with the UE 110.

The UE 110 may also arrange the carrying out of sidelink reference signal detection, reception and measurement on further sidelink reference signals from further objects in the environment.

Subsequent to detecting, receiving (1108) and measuring the sidelink reference signal, the associated vehicle may then transmit the sidelink reference signal measurement data to the UE 110. Notably, the sidelink reference signal measurement data transmitted from the associated vehicle to the UE 110 may have a pre-defined format. Alternatively, the sidelink reference signal measurement data transmitted from the associated vehicle to the UE 110 may have a proprietary format.

Upon receiving the sidelink reference signal measurement data, the UE 110 may determine (step 1110) that a Mobility event has occurred. Responsive to the determining (step 1110), the UE 110 may produce a Sidelink Mobility Measurement report. The UE 110 may then transmit (1112) the Sidelink Mobility Measurement report to the T-TRP 170.

Determining (step 1110) that a Mobility event has occurred relates to detecting that the sidelink reference signal measurement data includes a value that has exceeded a threshold for a particular duration.

The UE Capability Extension response 1200 transmitted (1106), to the UE 110 by the TRP 170, may use the SidelinkMobilityMeasurementConfig parameter to configure the UE 110 with information defining Mobility events that are based on the measurements carried out on sidelink reference signals. In the example UE Capability Extension response 1200 of FIG. 12, the UE 110 is configured to monitor for a Mobility event defined by at least three sidelink reference signals being detected with an reference signal received power (RSRP) below −120 dB for a duration of 40 ms.

The Mobility event is referenced in a Mobility Event parameter, which can further contain: an Event Type parameter; an Event Threshold parameter; an Event RSRP Threshold parameter; and an Event Duration parameter. The Event Type parameter may be used to describe the event to be triggered. The Event Threshold may provide a value for the threshold for the event to be triggered. The Event RSRP Threshold may provide a value for the threshold of the reference signal received power for the event to be triggered. The Event Duration parameter may be provide a value for an amount of time the value needs to exceed the threshold for the event to be triggered.

The UE 110 may transmit (1112) the Sidelink Mobility Measurement report to the T-TRP 170 over, e.g., a PUCCH or a PUSCH. The Sidelink Mobility Measurement report transmitted (1112) from the UE 110 to the T-TRP 170 may include fields designated to carry values for the Sidelink reference signal ID, the number of sidelink reference signals, the RSRP of each sidelink reference signal, etc. The values carried in these fields can be positive integer/decimal/real values, strings of characters or values from an enumerated table.

Following the reception (1110) of the Sensing Measurement report from the UE 110, the T-TRP 170 may then determine (step 1112) that a Mobility Command message is to be transmitted (1114) to the UE 110. In some instances, the Mobility Command message may be transmitted (1114), to the UE 110, as a higher-layer signaling message (e.g., using RRC signaling). In some other instances, the Mobility Command message may be transmitted (1120), to the UE 110, as a lower-layer signaling message (e.g., using a MAC-CE).

The object with which the mobile communication device exchanges communication to carry out an association procedure is not limited to self-driving vehicles. Depending on the situation or the scenario, the object with which the mobile communication device exchanges communication to carry out an association procedure may be a mining vehicle (e.g., excavation vehicles), a vehicle used in agriculture (e.g., tractors), a non-terrestrial device (e.g., drone), a medical device (e.g., a heart-beat sensor, a blood pressure sensor, etc.), other electronic devices (e.g., smartphones, tablets, laptops, AR/VR goggles, smart watches, televisions).

In some embodiments, the association procedure between the object and the mobile communication device uses the same type of communication protocol between the mobile communication device and its serving device; both links may be established as Uu links (i.e., a link using an air interface of the type used between a UE 110 and a Terrestrial Radio Access Network of the known Universal Mobile Telecommunications System or 4G Long Term Evolution or 5G New Radio).

In some embodiments, the association procedure between the object and the mobile communication device uses a different type of communication protocol between the mobile communication device and its serving device; the link between the object and the mobile communication device may be established as: a Bluetooth™ link; a Wi-Fi™ link; and a sidelink. The link between the mobile communication device and its serving device may be established as a Uu link (i.e., a link using an air interface of the type used between a UE 110 and a Terrestrial Radio Access Network of the known Universal Mobile Telecommunications System).

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method for performing at a mobile communication device, the method comprising:
receiving, from an object to which a sensor is attached, sensing capability information for the sensor;
transmitting, to a serving device, a first message including the sensing capability information; and
receiving, from the serving device, a second message including configuration information for the sensor.

2. The method of claim 1, further comprising transmitting, to the object, the configuration information for the sensor.

3. The method of claim 1, further comprising:
receiving, from the serving device, a third message including updated configuration information for the sensor, the updated configuration information for the sensor further comprising one or more of:
an identifier for the sensor;
an indication of a sensing event type for the sensor;
an indication of a threshold for a sensing event for the sensor; or
an indication of a duration for the sensing event for the sensor.

4. The method of claim 1, further comprising:
receiving, from the object, sensing measurement data; and
transmitting, to the serving device, the sensing measurement data.

5. The method of claim 4, further comprising:
receiving, from the serving device, instructions to switch to a connected state with a further serving device; and
establishing the connected state with the further serving device.

6. The method of claim 4, further comprising:
determining that a sensing event has occurred; and
responsive to the determining, triggering the transmitting the sensing measurement data.

7. The method of claim 1, wherein the object is a vehicle.

8. The method of claim 1, wherein the sensing capability information comprises at least one of a sensor type for the sensor, an indication of a sensing range for the sensor, an indication of an available measurement type for measurements that are capable of being carried out by the sensor, an indication of an available measurement frequency for measurements that are capable of being carried out by the sensor, or an identifier for the sensor.

9. The method of claim 8, wherein the indication of an available measurement type may indicate that a radial velocity of an object is capable of being sensed by the sensor or that a quantity of objects is capable of being sensed by the given sensor.

10. The method of claim 1, wherein the configuration information comprise at least one of an identifier for the sensor, an indication of a type of measurement to be carried out by the sensor, an indication of a periodicity of measurements to be carried out by the sensor, an indication of a frequency of reporting measurements that have been carried out by the sensor, an indication that a sidelink reference signal is to be measured, an indication of an identity of the sidelink reference signal, an indication of a reference signal received power threshold for the sidelink reference signal, or an indication of a scrambling identifier for the sidelink reference signal.

11. A method for performing at a serving device, the method comprising:
receiving, from a mobile communication device, a first message including sensing capability information for a sensor associated with the mobile communication device;
responsive to the receiving, transmitting, to the mobile communication device, a second message including configuration information for the sensor;
receiving, from the mobile communication device, sensing measurement data obtained at the sensor;
determining, from the sensing measurement data, that the mobile communication device is to be switched to a further serving device; and
transmitting, to the mobile communication device, instructions to switch to the further serving device.

12. The method of claim 11, wherein the determining relates to an amount of vehicular traffic on a road on which the mobile communication device is operating, a temperature of an environment in which the mobile communication device is operating, or working conditions for people in an environment in which the mobile communication device is operating.

13. The method of claim 11, wherein the transmitting the instructions to switch comprises transmitting radio resource control signaling or a media access control-control element.

14. An apparatus comprising:
at least one processor coupled with a memory storing instructions, wherein when the instructions are executed by the at least one processor, the apparatus is caused to perform a operations comprising:
receiving, from an object to which a sensor is attached, sensing capability information for the sensor;
transmitting, to a serving device, a first message including the sensing capability information; and
receiving, from the serving device, a second message including configuration information for the sensor.

15. The apparatus of claim 14, wherein the operations further comprise transmitting, to the object, the configuration information for the sensor.

16. The apparatus of claim 14, wherein the operations further comprise receiving, from the serving device, a third message including updated configuration information for the sensor, the updated configuration information for the sensor further comprising one or more of:
an identifier for the sensor;
an indication of a sensing event type for the sensor;
an indication of a threshold for a sensing event for the sensor; or
an indication of a duration for the sensing event for the sensor.

17. The apparatus of claim 14, wherein the operations further comprise:
receiving, from the object, sensing measurement data; and
transmitting, to the serving device, the sensing measurement data.

18. The apparatus of claim 17, wherein the operations further comprise:
receiving, from the serving device, instructions to switch to a connected state with a further serving device; and
establishing the connected state with the further serving device.

19. The apparatus of claim 17, wherein the operations further comprise:
determining that a sensing event has occurred; and
responsive to the determining, triggering the transmitting the sensing measurement data.

20. The apparatus of claim 14, wherein the object is a vehicle.
